(19) United States
(12) Patent Application Publication
(10) Pub. No.: US 2025/0308742 A1
(43) Pub. Date: Oct. 2, 2025

(54) REACTOR

(71) Applicant: HONDA MOTOR CO., LTD., Tokyo (JP)

(72) Inventors: Ryota KITAMOTO, Wako-shi (JP); Taro MATOBA, Wako-shi (JP)

(21) Appl. No.: 19/064,848

(22) Filed: Feb. 27, 2025

(30) Foreign Application Priority Data
Mar. 29, 2024 (JP) 2024-057536

(51) Int. Cl. H01F 27/02; H01F 27/08; H01F 27/28

(52) U.S. Cl. CPC H01F 27/022; H01F 27/08; H01F 27/28

(57) ABSTRACT

The present invention provides a reactor in which a coil is potted inside a container having a bottom surface with which a refrigerant comes into contact, including: a bus bar which is joined to the coil such that electricity can pass therethrough; and an insulation and heat dissipation sheet (connecting part) which connects the bus bar and the container while electrically disconnecting and freely transferring heat between the bus bar and the container.

### REFERENCE TO RELATED APPLICATIONS

The present invention relates to and asserts priority from Japanese patent application No. 2024-057536 filed on Mar. 29, 2024, and incorporates the entirety of the contents and subject matter of all the above application herein by reference.

### BACKGROUND OF THE INVENTION

### 1. Technical Field

The present invention relates to a reactor.

### 2. Background Art

Conventionally, an electronic converter in which columnar cooling terminals are provided on a terminal block disposed in a housing has been known (for example, see JP6233541B1). Specifically, this electronic converter is such that bus bars are electrically connected to upper ends of cooling terminals, and lower ends of the cooling terminals are thermally connected to a cooling mechanism which is disposed on a bottom part of the housing.

According to such an electronic converter, Joule heat generated in the bus bars can be transferred to the cooling mechanism on the bottom of the housing via the cooling terminal.

Meanwhile, a power converter for converting electric power between a battery and a motor, for example, is installed in electrical vehicles, HEVs (Hybrid Electrical Vehicles), and the like. Such a power converter includes an intelligent power module, a capacitor, a DC-DC converter, a reactor, and the like.

The reactor is structured by potting coils formed of winding wound around a core in a predetermined container with resin. The ends of the coils are connected to the bus bars, and the bus bars generate Joule heat. For this reason, it is desired to cool the bus bars in the reactor.

However, the reactor is such that most of the space inside the container is occupied by the coils potted with the resin. For this reason, it is difficult to apply a conventional terminal block provided with a cooling terminal (for example, see JP6233541B1) for cooling the bus bars of the reactor.

### SUMMARY OF INVENTION

An object of the present invention is to provide a reactor which can efficiently cool a bus bar electrically connected to a coil even with a configuration in which the coil is potted inside a container with resin.

The present invention is a reactor in which a coil is potted inside a container having a bottom surface with which a refrigerant comes into contact, comprising: a bus bar which is joined to the coil such that electricity can pass therethrough; and a connecting part which connects the bus bar and the container while electrically disconnecting and freely transferring heat between the bus bar and the container.

According to the reactor of the present invention, a bus bar which is electrically connected to a coil can be efficiently cooled even with a configuration in which the coil is potted inside a container with resin.

### BRIEF DESCRIPTION OF DRAWINGS

FIG. 1 is an entire perspective view of a reactor according to a first embodiment of the present invention.

FIG. 2 is a partially-enlarged sectional view taken along II-II at a cooling terminal block side of FIG. 1.

FIG. 3A is a partially-enlarged perspective view of a reactor according to a second embodiment of the present invention.

FIG. 3B is sectional view taken along IIIB-IIIB of FIG. 3A.

FIG. 4A is a partially-enlarged perspective view of a reactor according to a third embodiment of the present invention.

FIG. 4B is a sectional view taken along IVB-IVB of FIG. 4A.

### DESCRIPTION OF EMBODIMENTS

Next, modes (embodiments) for carrying out a reactor of the present invention is described in detail with reference to the drawings as appropriate.

Hereinbelow, the present invention is described by giving as an example a reactor included in a power converter which is mounted on an electrical vehicle, a HEV (Hybrid Electrical Vehicle), a fuel-cell vehicle, or the like and is disposed between a load such as a motor and a battery; however, the present invention is not limited thereto.

The reactor of the present embodiment is configured to include a cooling terminal block for bus bars at a position adjacent to an outer side of a container in which coils are potted with resin.

### First Embodiment

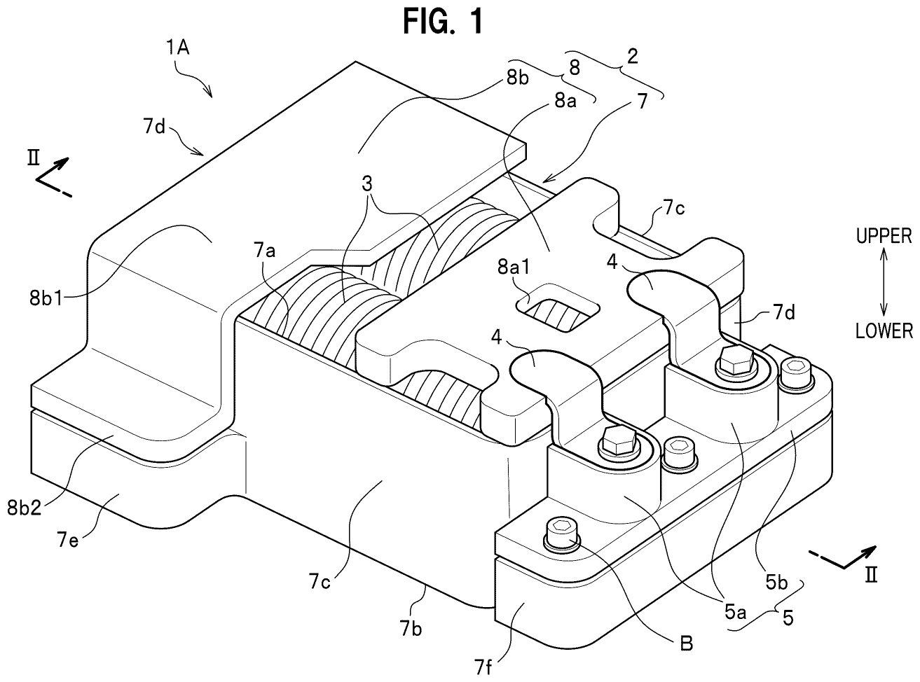

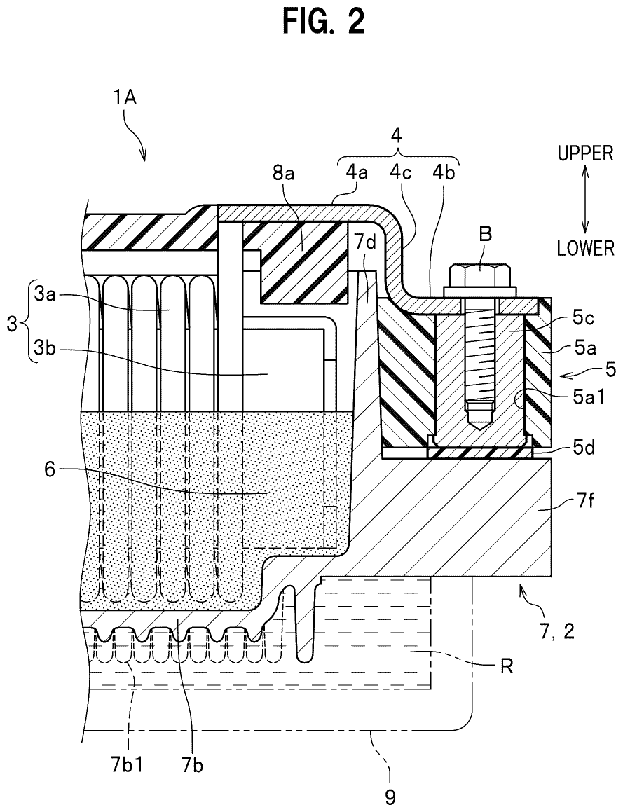

FIG. 1 is an entire perspective view of a reactor 1A according to a first embodiment of the present invention. FIG. 2 is a partially-enlarged sectional view taken along II-II at a side of a cooling terminal block 5 of FIG. 1.

Note that the vertical direction in the following description is based on the vertical direction which is shown in FIG. 1 and coincides with the vertical direction when the reactor 1A is mounted on a power converter (not shown).

As shown in FIG. 1, the reactor 1A includes a container 2, a coil 3, bus bars 4, and a cooling terminal block 5. Note that the cooling terminal block 5 in the present embodiment also serves as a power supply terminal which electrically connects the bus bars 4 and bus bars which are not shown, and which are electrically connected to the motor side or the battery side which is not shown. The cooling terminal block 5 corresponds to a “terminal block” described in Claims.

As shown in FIG. 1, the container 2 is structured with a box member having a substantially cuboid shape. Specifically, the container 2 includes a container main body 7 which has an opening part 7a having a substantially rectangular shape in a plan view and a cover member 8 which partially covers the opening part 7a.

As shown in FIG. 1, the container main body 7 in the present embodiment includes a rectangular bottom plate 7b, two side plates 7c standing upright respectively from two long sides of the bottom plate 7b, and two side plates 7d standing upright respectively from two short sides of the bottom plate 7b. The container main body 7 in the present embodiment is assumed to be a die-cast product of an aluminum alloy, but is not limited to this.

On one end side of the side plates 7c in the longitudinal direction (extension direction of the long sides of the bottom plate 7b), an attachment part 7e for a second cover member 8b, which is described below, is formed at a position closer to the bottom plate 7b. This attachment parts 7e is formed in a seat shape which partially bulges in a direction separating from the side plate 7c in the lower end part on the one end side of the side plate 7c.

In addition, among the pair of side plates 7d facing each other, in the side plate 7d which is disposed on the other end of the side plate 7c in the longitudinal direction, an attachment part 7f for the cooling terminal block 5, which is described below, is formed. This attachment part 7f is described in detail below together with the cooling terminal block 5.

As shown in FIG. 2, a plurality of cooling fins 7b1 are provided upright on the lower surface of the bottom plate 7b.

The lower surface of such a bottom plate 7b is configured to come into contact with a refrigerant R which flows through in a predetermined refrigerant chamber 9 as indicated by an imaginary line (a dash-dot-dot line), which is provided in a lower part of the container main body 7. A lower surface of this bottom plate 7b corresponds to a “bottom surface” of the container 2 with which the refrigerant R comes into contact.

By the way, the refrigerant R in the present embodiment is assumed to be a cooling water which is circulated through a circulation flow passage including the refrigerant chamber 9 in the middle of the flow passage by a pump (not shown), but is not limited to this.

Referring back to FIG. 1, the cover member 8 is configured to include a first cover member 8a and a second cover member 8b. The first cover member 8a and the second cover member 8b are formed of synthetic resin having electrical insulation.

The first cover member 8a is formed of a substantially rectangular plate body which is disposed across upper end edges of the pair of side plates 7c and an upper end edge of the side plate 7d at a position closer to the attachment part 7f.

In the first cover member 8a, a plurality of opening parts 8a1 through which the inside and the outside of the container 2 communicate with each other are formed.

The first cover member 8a is fixed to upper end parts of the side plates 7c of the container main body 7.

The second cover member 8b is structured with a plate body, the section of which is bent into a hat shape. The second cover member 8b is disposed along an upper end edge of the side plate 7d on the opposite side from the side plate 7d on which the first cover member 8a is disposed.

A top board part 8b1 corresponding to a top surface of the hat shape of the second cover member 8b is disposed at a predetermined interval from the first cover member 8a, and is fixed to the upper end parts of the side plates 7d.

In addition, a flange part 8b2 corresponding to a flange part of the hat shape of the second cover member 8b is fixed to the attachment part 7e.

The coils 3 (see FIG. 1) each have a cylindrical shape in which a winding 3a surface-treated with insulating treatment is spirally wound around an outer peripheral surface of a core 3b (see FIG. 2) formed of an iron core or the like surface-treated with insulating treatment.

As shown in FIG. 1, the reactor 1A of the present embodiment includes two coils 3. The coils 3 are disposed side by side between the pair of side plates 7c. That is, the coils 3 are housed in the container 2 such that end parts of the coils 3 in the center axis direction face the side plate 7d side.

In addition, as shown in FIG. 2, the coil 3 is potted with a resin 6 inside the container 2. This causes at least lower halve of the coils 3 buried in the resin 6 inside the container 2. The resin in the present embodiment is assumed to be thermosetting resin such as epoxy resin having heat resistance.

After being disposed inside the container 2, the coils 3 are fixed to the container 2 by curing the uncured resin poured into the container 2.

In addition, the ends of the windings 3a forming such coils 3 are drawn out upward from the end parts of the coils 3 in the center axis direction and are electrically connected to the bus bars 4 outside the container 2.

Referring back to FIG. 1, two bus bars 4 are disposed along the lateral direction of the side plate 7d of the container main body 7 to correspond to the two coils 3.

The bus bars 4 in the present embodiment are each formed of a copper plate bent in a crank shape as shown in FIG. 1.

Specifically, as shown in FIG. 2, the bus bar 4 includes a coil connecting part 4a which is connected to the winding 3a drawn out of the coil 3, a supported part 4b which is supported on the container 2 side with the cooling terminal block 5 interposed therebetween, and an intermediate part 4c which connects the coil connecting part 4a and the supported part 4b. Note that in FIG. 2, reference sign 8a indicates a first cover member.

As shown in FIG. 1, the cooling terminal block 5 includes two bus bars supporting parts 5a which are provided to correspond to the two bus bars 4, and a plate-shaped base part 5b which integrally joins lower end parts of these bus bars supporting parts 5a. In addition, as shown in FIG. 2, the cooling terminal block 5 further includes collar members 5c which are made of copper and an insulation and heat dissipation sheet 5d.

Note that the collar member 5c corresponds to a “heat-conductive member” described in Claims. The insulation and heat dissipation sheet 5d corresponds to a “connecting part” described in Claims.

Referring back to FIG. 1, first, the attachment part 7f of the cooling terminal block 5 is described.

The aforementioned attachment part 7f of the container main body 7 is formed in a seat shape which bulges from a lower end part of the side plate 7d in a direction separating from the side plate 7d to have substantially the same lateral width as the lateral width of the side plate 7d. Specifically, the attachment part 7f is a block body having a substantially cuboid shape which is integrally molded with the side plate 7d.

The base part 5b included in the cooling terminal block 5 is structured with a rectangular plate body having the same flat-surface shape as the attachment part 7f.

This base part 5b is fastened to the attachment part 7f with bolts B at a plurality of portions.

As shown in FIG. 2, the bus bar supporting part 5a included in the cooling terminal block 5 is formed in a cylindrical shape.

In a center hole 5a1 which vertically penetrates the bus bar supporting parts 5a, a collar member 5c (heat-conductive member) having a columnar shape is fixed.

In the collar member 5c, a thread part with which the bolt B meshes is formed.

The supported part 4b of the bus bar 4 is connected to an upper end surface of the collar member 5c with the bolt B.

A lower end surface of the collar member 5c is thermally connected to the attachment part 7f of the container main body 7 with the insulation and heat dissipation sheet 5d interposed therebetween.

The insulation and heat dissipation sheet 5d (connecting part) connects the bus bar 4 and the container 2 while electrically disconnecting and freely transferring heat between the bus bar 4 and the container 2.

The insulation and heat dissipation sheet 5d in the present embodiment is assumed to be formed of thermosetting resin having electrical insulation and heat resistance.

Such thermosetting resin includes, for example, epoxy resin, cyanate resin, benzoxazine resin, unsaturated polyester resin, phenol resin, melamine resin, silicone resin, maleimide resin, acrylic resin, polyamide resin, and the like. In addition, a heat-conductive filler may be further added to the insulation and heat dissipation sheet 5d. The heat-conductive filler includes, for example, silicon oxide, aluminum oxide, boron nitride, silicon nitride, aluminum nitride, and the like.

### <<Actions and Effects>>

Next, the actions and effects achieved by the reactor 1A (see FIG. 2) according to the first embodiment is described.

The reactor 1A of the present embodiment is a reactor 1A in which the coil 3 is potted inside the container 2 having the bottom surface with which the refrigerant R comes into contact, comprising the bus bar 4 which is joined to the coil 3 such that electricity can pass therethrough; and the insulation and heat dissipation sheet 5d (connecting part) which connects the bus bar 4 and the container 2 while electrically disconnecting and freely transferring heat between the bus bar 4 and the container 2.

According to such a reactor 1A, Joule heat generated in the bus bar 4 can be efficiently transferred to the container 2 even with a configuration in which the coil 3 is potted inside the container 2 with the resin 6. The reactor 1A can efficiently cool the bus bar 4 while preventing electric leakage to the container 2.

In addition, in this reactor 1A, the cooling fin 7b1 is formed in the bottom surface of the container 2.

According to such a reactor 1A, the container 2 itself serves as a heat sink, so that the bus bar 4 can be further efficiently cooled.

In addition, this reactor 1A comprises the cooling terminal block 5 (terminal block) for the bus bar 4, which is adjacent to the outer side of the container 2, wherein the insulation and heat dissipation sheet 5d (connecting part) is disposed in the cooling terminal block 5 (terminal block).

According to such a reactor 1A, since a power supply terminal block (not shown) for connection to the motor side or the battery side and the cooling terminal block 5 can be integrated, a compact reactor 1A can be achieved.

In addition, in this reactor 1A, the insulation and heat dissipation sheet 5d is interposed between the bus bar 4 and the container 2.

According to such a reactor 1A, it is possible to surely prevent electric leakage to the container 2 while maintaining favorable heat transfer between the bus bar 4 and the container 2 by interposing the insulation and heat dissipation sheet 5d.

In addition, in this reactor 1A, the collar member 5c (heat-conductive member) made of copper is disposed between the bus bar 4 and the insulation and heat dissipation sheet 5d.

According to such reactor 1A, it is possible to keep a distance between the bus bar 4 and the insulation and heat dissipation sheet 5d, and to thus improve the degree freedom of design of the cooling terminal block 5.

### Second Embodiment

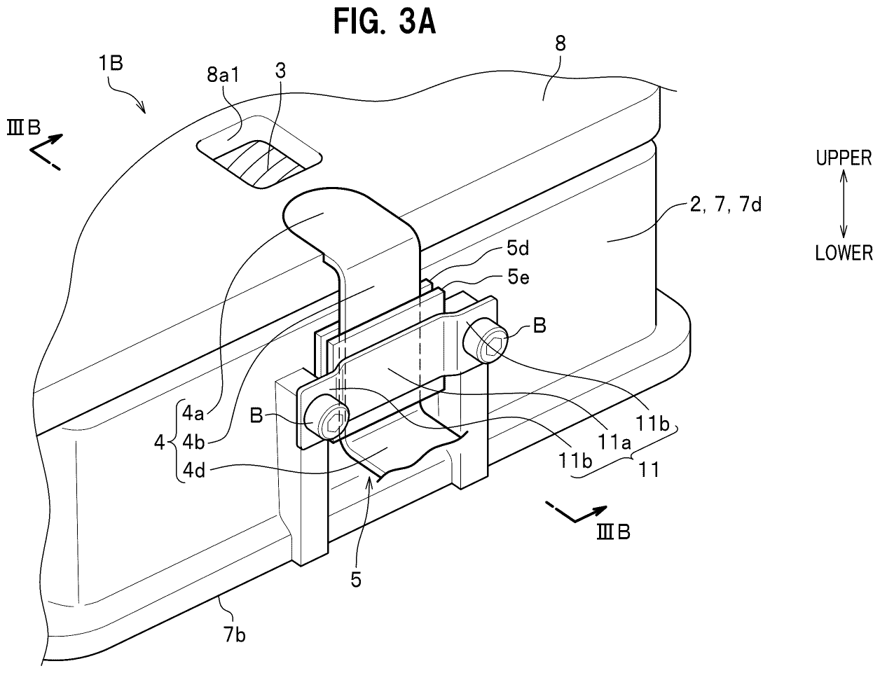

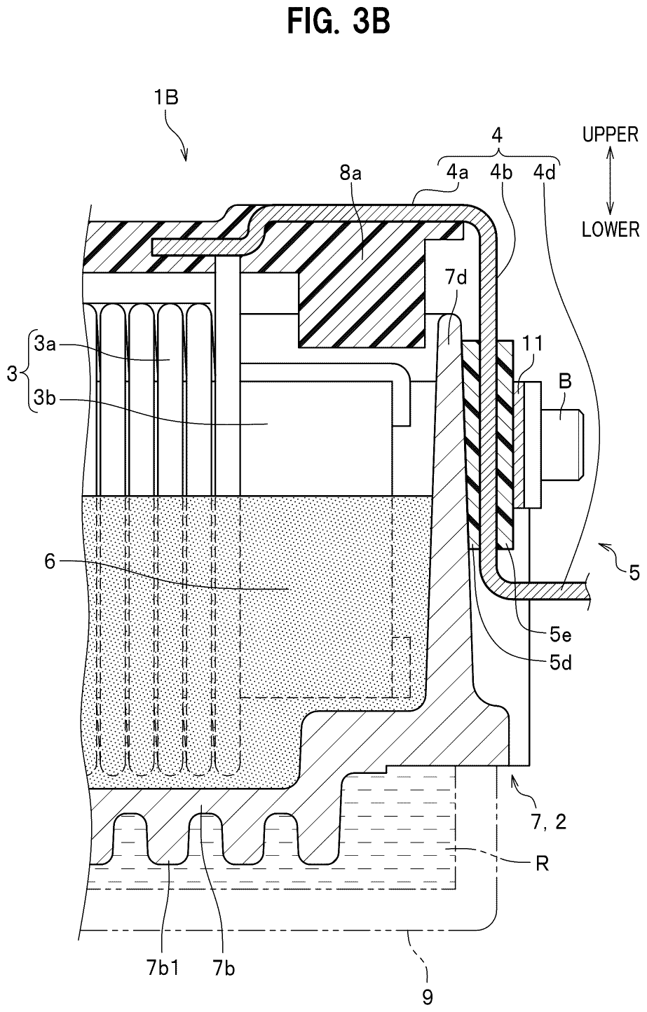

FIG. 3A is a partially-enlarged perspective view of a reactor 1B according to a second embodiment of the present invention. This FIG. 3A is a partially-enlarged perspective view of a cooling terminal block 5 attached to a side plate 7d of a container 2 (a container main body 7). FIG. 3B is a sectional view taken along IIIB-IIIB of FIG. 3A. Note that in this second embodiment, the same constituent elements as those in the first embodiment are denoted by the same reference signs, and the detailed description thereof is omitted.

As shown in FIG. 3A, in the reactor 1B in the second embodiment, the cooling terminal block 5 for a bus bar 4 is attached to the side plate 7d which forms a side wall of the container 2.

The cooling terminal block 5 according to the present embodiment includes an insulation and heat dissipation sheet 5d, an insulation and heat dissipation sheet 5e, and a leaf spring 11.

In FIG. 3A, reference sign 3 indicates a coil which can be seen through an opening part 8a1 of a cover member 8, and reference sign 4 indicates a bus bar.

Note that although the present embodiment includes two coils 3 and two bus bars 4 as in the case of the coils 3 (see FIG. 1) and the bus bars 4 (see FIG. 1) in the first embodiment, description of one of the coils 3 and one of the bus bars 4 is omitted in FIG. 3A for the convenience of depiction.

The bus bar 4 in the present embodiment is formed of a copper plate bent in a crank shape as in the case of the bus bar 4 (see FIG. 2) in the first embodiment.

Specifically, as shown in FIG. 3B, the bus bar 4 in the present embodiment includes a coil connecting part 4a which is connected to a winding 3a drawn out of the coil 3, a supported part 4b which is supported on the container 2 side, and an extension part 4d which extends in a direction separating from the side plate 7d. Note that the extension part 4d in the present embodiment is assumed to be connected to a power supply terminal block which is not shown; however, in the case where the cooling terminal 5 also serves as a power supply terminal block, the extension part 4d may be omitted.

As shown in FIG. 3B, in the cooling terminal block 5 in the present embodiment, the insulation and heat dissipation sheet 5d (connecting part) is interposed between the bus bar 4 (supported part 4b) and the side plate 7d of the container 2 (container main body 7). Specifically, the side plate 7d which forms a side wall of the container 2 and the insulation and heat dissipation sheet 5d are in contact with each other, and the insulation and heat dissipation sheet 5d and the bus bar 4 (supported part 4b) are in contact with each other.

Referring back to FIG. 3A, the leaf spring 11 is formed of a bent plate body which is long in the lateral direction. Specifically, the leaf spring 11 includes a protruding part 11a which has a flat surface facing the side plate 7d and which protrudes in an angular C-shape toward the side plate 7d, and fixed parts 11b which are formed on both ends of the protruding part 11a in the longitudinal direction.

The leaf spring 11 is configured such that the protruding part 11a presses the bus bar 4 (supported part 4b) toward the side plate 7d of the container 2 via the insulation and heat dissipation sheet 5e when the fixed parts 11b at both ends are fastened to the side plate 7d with bolts B.

The leaf spring 11 corresponds to an “energizer” described in Claims.

As shown in FIG. 3B, the leaf spring 11 presses the insulation and heat dissipation sheet 5e, the bus bar 4 (supported part 4b), and the insulation and heat dissipation sheet 5d (connecting part) toward the side plate 7d to integrally support these on the container 2.

Note that in FIG. 3B, reference sign 3b indicates a core of the coil 3, reference sign 6 indicates a resin, reference sign 7b1 indicates cooling fins provided on a lower surface (a bottom surface) of a bottom plate 7b of the container main body 7, and reference sign R indicates a refrigerant which flows through a refrigerant chamber 9.

### <<Actions and Effects>>

Next, the actions and effects achieved by the reactor 1B (see FIG. 3B) according to the second embodiment is described.

In the reactor 1B according to the second embodiment, the insulation and heat dissipation sheet 5d (connecting part) is interposed between the bus bar 4 and the side plate 7d, which is the side wall of the container 2.

According to such a reactor 1B, the insulation and heat dissipation sheet 5d (connecting part) can be disposed to be adjacent to the container 2. In this way, the reactor 1B allows the cooling terminal block 5 to have a simpler configuration, and a further compact reactor 1B can be achieved.

In addition, in the reactor 1B, the side plate 7d, which is the side wall of the container 2, and the insulation and heat dissipation sheet 5d (connecting part) are in contact with each other, and the insulation and heat dissipation sheet 5d (connecting part) and the bus bar 4 are in contact with each other. Then, the reactor 1B includes the leaf spring 11 (energizer) which presses the bus bar 4 toward the side plate 7d, which is the side wall of the container 2.

According to such a reactor 1B, Joule heat generated in the bus bar 4 can be more efficiently transferred to the container 2. According to the reactor 1B, the cooling efficiency of the bus bar 4 is further improved.

In addition, in the reactor 1B, the leaf spring 11 (energizer) is fixed to the side plate 7d, which is the side wall of the container 2.

According to such a reactor 1B, Joule heat generated in the bus bar 4 is transferred to the side plate 7d, which is the side wall of the container 2, via the insulation and heat dissipation sheet 5e and the leaf spring 11. According to the reactor 1B, Joule heat generated in the bus bar 4 can be further efficiently transferred to the container 2.

### Third Embodiment

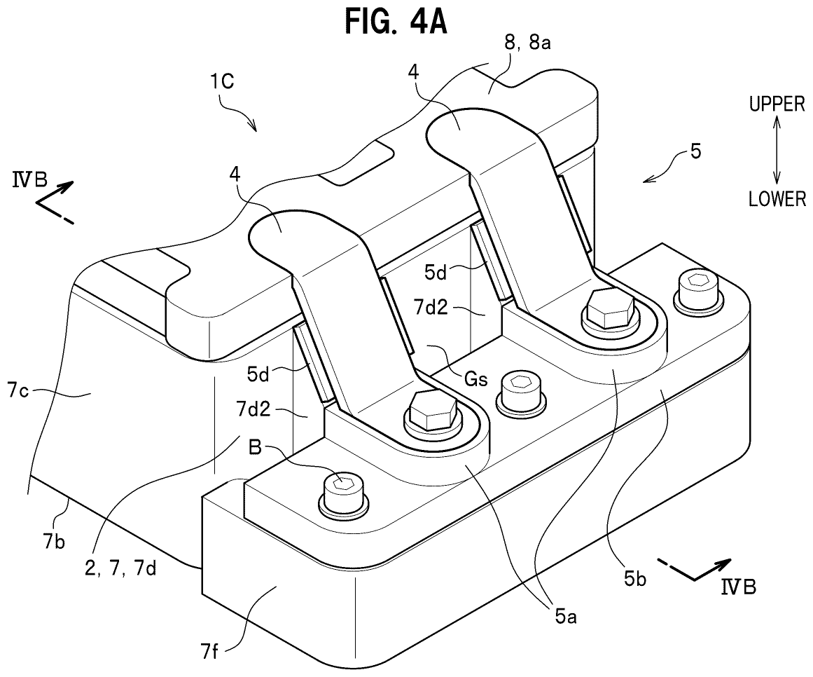

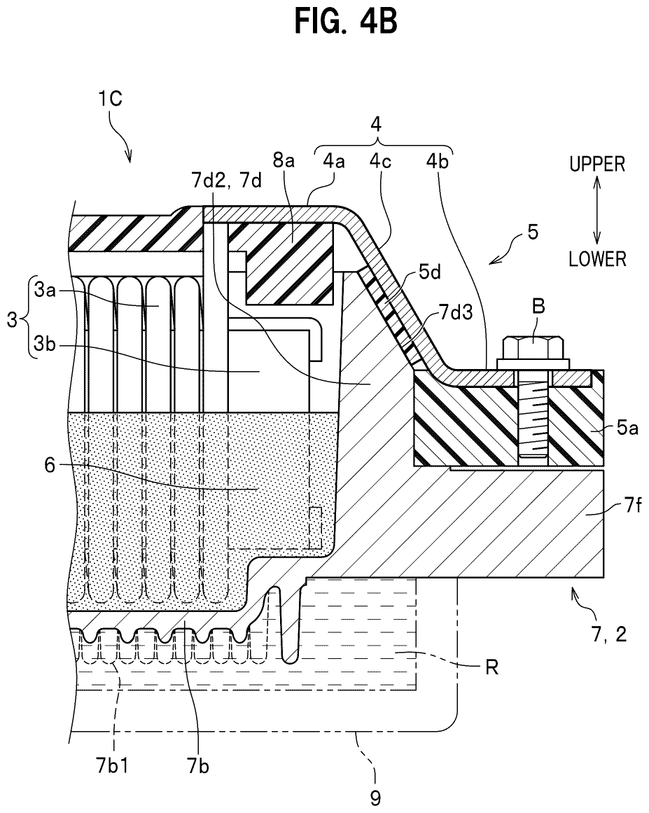

FIG. 4A is a partially-enlarged perspective view of a reactor 1C according to a third embodiment of the present invention. FIG. 4B is a sectional view taken along IVB-IVB of FIG. 4A. Note that in this third embodiment, the same constituent elements as those in the first embodiment and the second embodiment are denoted by the same reference signs, and the detailed description thereof is omitted.

As shown in FIG. 4A, in a reactor 1C according to the third embodiment, two bus bars 4 are disposed along the lateral direction of a side plate 7d of a container main body 7 to correspond to two coils (not shown) as in the case of the reactor 1A (see FIG. 1) according to the first embodiment.

As shown in FIG. 4B, the bus bar 4 in the present embodiment includes a coil connecting part 4a which is connected to a winding 3a drawn out of the coil 3, a supported part 4b which is supported on the container 2 side, and an intermediate part 4c which connects the coil connecting part 4a and the supported part 4b. Note that in FIG. 4B, reference sign 8a indicates a first cover member.

Referring back to FIG. 4A, the cooling terminal block 5 in the present embodiment is configured to include two bus bar supporting parts 5a which are provided to correspond to the two bus bars 4, a plate-shaped base part 5b which integrally joins lower end parts of these bus bar supporting parts 5a, and insulation and heat dissipation sheets 5d (connecting part).

In FIG. 4A, reference sign 8a indicates the first cover member. In addition, reference sign 7f indicates an attachment part to which the base part 5b is fastened with bolts B.

As shown in FIG. 4B, in the cooling terminal block 5 in the present embodiment, the insulation and heat dissipation sheet 5d (connecting part) is interposed between the bus bar 4 (intermediate part 4c) and the side plate 7d of the container 2 (container main body 7).

Specifically, the insulation and heat dissipation sheet 5d is in contact with an inclined surface 7d3 formed in a projecting part 7d2 of the side plate 7d, and the bus bar 4 (intermediate part 4c) is in contact with the insulation and heat dissipation sheet 5d.

Note that as shown in FIG. 4A, the projecting part 7d2 is formed in a rail shape which is formed to project to an outer side of the container 2 more than a general surface Gs of the side plate 7d and which vertically extends.

Then, as shown in FIG. 4B, the inclined surface 7d3 has a surface which is displaced to gradually separate toward the outer side of the container 2 as extending downward in the side plate 7d, which is the side wall of the container 2.

Note that in FIG. 4B, reference sign 3b indicates a core of the coil 3, reference sign 6 indicates a resin, reference sign 7b1 indicates cooling fins provided on a lower surface (a bottom surface) of a bottom plate 7b of the container main body 7, and reference sign R indicates a refrigerant which flows through a refrigerant chamber 9. Reference sign 7f indicates the attachment part to which the base part 5b (see FIG. 4A) is fastened.

### <<Actions and Effects>>

Next, actions and effects achieved by the reactor 1C (see FIG. 4B) according to the third embodiment is described.

In the reactor 1C according to the third embodiment, the side plate 7d, which is the side wall of the container 2, includes the inclined surface 7d3 which is displaced to gradually separate toward an outer side of the container 2 as extending downward, and the insulation and heat dissipation sheet 5d (connecting part) is provided on the inclined surface 7d3.

According to such a reactor 1C, the work of attaching the insulation and heat dissipation sheet 5d (connecting part) to the side plate 7d, which is the side wall of the container 2, becomes easier than the case of attaching the insulation and heat dissipation sheet 5d (connecting part) to a vertical wall (for example, the general surface Gs of the side plate 7d) of the container 2, for example.

In addition, according to such a reactor 1C, a larger contact area of the insulation and heat dissipation sheet 5d (connecting part) to the side plate 7d of the container 2 can be secured than the case of attaching the insulation and heat dissipation sheet 5d (connecting part) to the vertical wall (for example, the general surface Gs of the side plate 7d) of the container 2. According to the reactor 1B, Joule heat generated in the bus bar 4 can be furthermore efficiently transferred to the container 2.

Although the present embodiment has been described above, the present invention is not limited to the above-described embodiments, and can be carried out in various modes.

Although the first embodiment to the third embodiment have been described in which the number of the coils 3 is two, the reactor of the present invention is not limited to this, and the number of the coils 3 can be reduced or increased depending on its application.

In addition, in the first embodiment to the third embodiment, only the terminal block (cooling terminal block 5) for the bus bars 4 which are connected to the windings 3a drawn out of one end sides of the coils 3 in the center axis direction has been described, a configuration in which the terminal block (cooling terminal block 5) is provided to bus bars 4 which are connected to windings 3a drawn out of the other end sides of coils 3 which are not shown in the center axis direction may be employed.
1a: Reactor
1b: Reactor
1c: Reactor
2: Container
3: Coil
4: Bus Bar
5: Cooling Terminal Block (Terminal Block)
5c: Collar Member (Heat-Conductive Member)
5d: Insulation and Heat Dissipation Sheet (Connecting Part)
7b1: Cooling Fin
7d: Side Plate
7d3: Inclined Surface
11: Leaf Spring (Energizer)
R: Refrigerant

What is claimed is:

1. A reactor in which a coil is potted inside a container having a bottom surface with which a refrigerant comes into contact, comprising:
a bus bar which is joined to the coil such that electricity can pass therethrough; and
a connecting part which connects the bus bar and the container while electrically disconnecting and freely transferring heat between the bus bar and the container.

2. The reactor according to claim 1, wherein a cooling fin is formed at the bottom surface of the container.

3. The reactor according to claim 1, comprising a terminal block for the bus bar, the terminal block being adjacent to an outer side of the container, wherein
the connecting part is disposed in the terminal block.

4. The reactor according to claim 3, wherein
the connecting part is an insulation and heat dissipation sheet, and
the insulation and heat dissipation sheet is interposed between the bus bar and the container.

5. The reactor according to claim 4, wherein a heat-conductive member is disposed between the bus bar and the insulation and heat dissipation sheet.

6. The reactor according to claim 4, wherein the insulation and heat dissipation sheet is interposed between the bus bar and a side wall of the container.

7. The reactor according to claim 6, wherein
the side wall of the container and the insulation and heat dissipation sheet are in contact with each other, and the insulation and heat dissipation sheet and the bus bar are in contact with each other, and
the reactor comprises an energizer for pressing the bus bar toward the side wall of the container.

8. The reactor according to claim 6, wherein
the side wall of the container includes an inclined surface which is displaced to gradually go away toward an outer side of the container as extending downward, and
the insulation and heat dissipation sheet is provided on the inclined surface.
